(19) United States
(12) Patent Application Publication
(10) Pub. No.: US 2022/0350415 A1
(43) Pub. Date: Nov. 3, 2022

(54) VISUAL SYMBOLIC INTERFACE FOR MEDIA DEVICES

(71) Applicant: ARRIS Enterprises LLC, Suwanee, GA (US)

(72) Inventors: Vinod JATTI, Bangalore (IN); Swaroop MAHADEVA, Bengaluru (IN)

(21) Appl. No.: 17/732,935

(22) Filed: Apr. 29, 2022

Related U.S. Application Data
(60) Provisional application No. 63/181,500, filed on Apr. 29, 2021.

(51) Int. Cl. G06F 3/01; G06V 40/10; G06V 40/20; H04N 5/232

(52) U.S. Cl. CPC G06F 3/017; G06V 40/107; G06V 40/28; H04N 5/23203

(57) ABSTRACT

An interface device is provided for use with a media device and a hand. The media device is configured to provide media and perform an action with reference to the media, the interface device including: a memory having instructions and a data structure stored therein including hand gesture data and an association associating the hand gesture data to the action; an imaging device configured to obtain an image of the hand and output image data based on the image of the hand; and a processor configured to execute the instructions stored on the memory to cause the interface device to: instruct the imaging device to obtain the image of the hand; obtain the image data; determine whether the image data corresponds to the hand gesture data; and generate a control signal to instruct the media device to perform the action when the image data corresponds to the hand gesture data.

### BACKGROUND

Embodiments of the present disclosure relate to using an interface device to operate a media device.

### SUMMARY

Aspects of the present disclosure are drawn to an interface device for use with a media device and a hand, the media device being configured to provide media and to perform an action with reference to the media, the interface device including: a memory having instructions and a data structure stored therein, the data structure including hand gesture data and an association associating the hand gesture data to the action; an imaging device configured to obtain an image of the hand and output image data based on the image of the hand; and a processor configured to execute the instructions stored on the memory to cause the interface device to: instruct the imaging device to obtain the image of the hand; obtain the image data; determine whether the image data corresponds to the hand gesture data; and generate a control signal to instruct the media device to perform the action when the image data corresponds to the hand gesture data.

In some embodiments, the interface device is further configured wherein the hand gesture data corresponds to a static hand gesture, and wherein the imaging device is configured to obtain the image of the hand as a static image.

In some further embodiments, the interface device is further configured wherein the imaging device is configured to obtain the image of the hand for a predetermined period of time, and wherein the processor is configured to execute the instructions stored on the memory to additionally cause the interface device to: instruct the imaging device to obtain the image of the hand for the predetermined period of time; determine whether the image data for the predetermined period of time corresponds the hand gesture data; and generate a control signal to instruct the media device to perform the action when the image data corresponds to the hand gesture data for the predetermined period of time.

In some embodiments, the interface device is further configured wherein the hand gesture data corresponds to a dynamic hand gesture, and wherein the imaging device is configured to obtain the image of the hand as a video image.

In some embodiments, the processor is configured to execute the instructions stored on the memory to additionally cause the interface device to: obtain the data structure from the memory; store the data structure on the external server; and access the data structure from the external server.

In some embodiments, the processor is configured to execute the instructions stored on the memory to additionally cause the interface device to: generate a media device instruction signal to instruct the media device to display an icon corresponding to the action; generate an imaging device instruction signal to instruct the imaging device to obtain a defining image of the hand and output defining image data based on the defining image of the hand; and create the data structure such that the defining image data is the hand gesture data, and the association associates the defining image data to the action.

Other aspects of the present disclosure are drawn to a method of using an interface device with a media device and a hand, the media device being configured to provide media and to perform an action with reference to the media, the method including: instructing, via a processor configured to execute instruction stored on a memory additionally having stored therein a data structure including hand gesture data and an association associating the hand gesture data to the action, an imaging device to obtain an image of the hand; obtaining, via the processor and from the imaging device, the image data based on the image of the hand; determining, via the processor, whether the image data corresponds the hand gesture data; and generating, via the processor, a control signal to instruct the media device to perform the action when the image data corresponds to the hand gesture data.

In some embodiments, the method is further configured wherein the hand gesture data corresponds to a static hand gesture, and wherein obtaining, via the processor and from the imaging device, the image data based on the image of the hand includes obtaining the image of the hand as a static image.

In some further embodiments, the method is further configured wherein obtaining, via the processor and from the imaging device, the image data based on the image of the hand includes obtaining the image of the hand for a predetermined period of time, and wherein the method further includes: instructing, via the processor, the imaging device to obtain the image of the hand for the predetermined period of time; determining, via the processor, whether the image data for the predetermined period of time corresponds the hand gesture data; and generating, via the processor, a control signal to instruct the media device to perform the action when the image data corresponds to the hand gesture data for the predetermined period of time.

In some embodiments, the method is further configured wherein the hand gesture data corresponds to a dynamic hand gesture, and wherein the instructing the imaging device to obtain the image of the hand includes instructing the imaging device to obtain the image of the hand as a video image.

In some embodiments, the method further includes obtaining, via the processor, the data structure from the memory; storing, via the processor, the data structure on the external server; and accessing, via the processor, the data structure from the external server.

In some embodiments, the method further includes generating, via the processor, a media device instruction signal to instruct the media device to display an icon corresponding to the action; generating, via the processor, an imaging device instruction signal to instruct the imaging device to obtain a defining image of the hand and output defining image data based on the defining image of the hand; and creating, via the processor, the data structure such that the defining image data is the hand gesture data, and the association associates the defining image data to the action.

Other aspects of the present disclosure are drawn to a non-transitory, computer-readable media having computer-readable instructions stored thereon, the computer-readable instructions is capable of being read by an interface device for use with a media device and a hand, the media device being configured to provide media and to perform an action with reference to the media, wherein the computer-readable instructions are capable of instructing the interface device to perform the method including: instructing, via a processor configured to execute instruction stored on a memory additionally having stored therein a data structure including hand gesture data and an association associating the hand gesture data to the action, an imaging device to obtain an image of the hand; obtaining, via the processor and from the imaging device, the image data based on the image of the hand; determining, via the processor, whether the image data corresponds to the hand gesture data; and generating, via the processor, a control signal to instruct the media device to perform the action when the image data corresponds to the hand gesture data.

In some embodiments, the computer-readable media is further configured wherein the computer-readable instructions are capable of instructing the interface device to perform the method wherein the hand gesture data corresponds to a static hand gesture, and wherein the obtaining, via the processor and from the imaging device, the image data based on the image of the hand includes obtaining the image of the hand as a static image.

In some embodiments, the computer-readable media is further configured wherein the computer-readable instructions are capable of instructing the interface device to perform the method wherein the obtaining, via the processor and from the imaging device, the image data based on the image of the hand includes obtaining the image of the hand for a predetermined period of time, and wherein the method further includes: instructing, via the processor, the imaging device to obtain the image of the hand for the predetermined period of time; determining, via the processor, whether the image data for the predetermined period of time corresponds to the hand gesture data; and generating, via the processor, a control signal to instruct the media device to perform the action when the image data corresponds to the hand gesture data for the predetermined period of time.

In some embodiments, the computer-readable media is further configured wherein the computer-readable instructions are capable of instructing the interface device to perform the method wherein the hand gesture data corresponds to a dynamic hand gesture, and wherein the instructing the imaging device to obtain the image of the hand includes instructing the imaging device to obtain the image of the hand as a video image.

In some embodiments, the computer-readable media is further configured wherein the computer-readable instructions are capable of instructing the interface device to additionally perform the method including: obtaining, via the processor, the data structure from the memory; and accessing, via the processor, the data structure from the external server.

In some embodiments, the computer-readable media is further configured wherein the computer-readable instructions are capable of instructing the interface device to additionally perform the method including: generating, via the processor, a media device instruction signal to instruct the media device to display an icon corresponding to the action; generating, via the processor, an imaging device instruction signal to instruct the imaging device to obtain a defining image of the hand and output defining image data based on the defining image of the hand; and creating, via the processor, the data structure such that the defining image data is the hand gesture data, and the association associates the defining image data to the action.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a communication network;

FIG. 2 illustrates a method of operating an interface device with visual symbols, in accordance with aspects of the present disclosure;

FIG. 3 illustrates a communication network, in accordance with aspects of the present disclosure;

FIG. 4 illustrates an exploded view of a media device, an interface device, a gateway device, and an external server;

FIG. 5 illustrates a chart showcasing non-limiting examples of user-made hand gestures and their respective functions;

FIG. 6 illustrates a chart showcasing non-limiting examples of pre-loaded hand gestures stored in the database and their respective functions; and

FIG. 7 illustrates a chart showcasing non-limiting examples of dynamic hand gestures and their respective functions.

### DETAILED DESCRIPTION

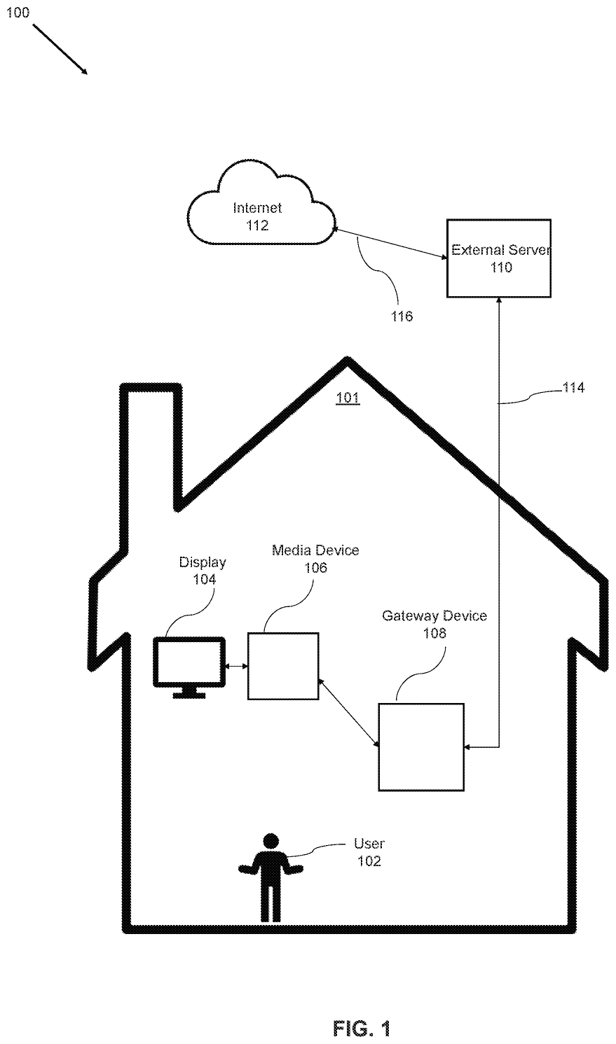

FIG. 1 illustrates a communication network 100.

As shown in FIG. 1, communication network 100 includes a residence 101, a user 102, a display 104, a media device 106, a gateway device 108, an external server 110, an Internet 112, and communication channels 114 and 116.

Media device 106 is connected to both display 104 and gateway device 108. A non-limiting example of a media device 106 is a set-top box, and a non-limiting example of display 104 is a television. Media device 106 is able to play media, which is then displayed on display 104 to user 102. Further, media device 106 is capable of streaming data via external server 110. Media device 106 is configured to wirelessly communicate with gateway device 108, e.g., via a Wi-Fi protocol. Gateway device 108 is configured to communicate with external server 110 via communication channel 114, and external server 110 is connected to Internet 112 via communication channel 116.

Many media devices today come with a list of features and applications for a user to access. Due to the many options, it may be difficult and tedious to navigate the interface to allow the user to access the media they are looking for using a traditional hand-held remote controller. As technology has progressed, some devices include voice interface, where users can speak to navigate their media devices. However, this technology may not be helpful to users who are speech or hearing impaired. Background noises may also alter the voice command given by the user. Hence, media devices need a simple interface that allows users to efficiently and effectively use to navigate their media devices.

What is needed is a system and method for enabling a touch-free interface for controlling media devices.

A system and method in accordance with the present disclosure enables a touch-free interface for controlling media devices.

In accordance with the present disclosure, a user will use an interface device when using a media device with a display device. The user may create a profile on the interface device. The interface device may be configured to have more than one user profile. The interface device is configured to read hand gestures from the user using a video capturing system/device. These hand gestures are associated with respective actions.

In operation, the interface device may have a database of default hand gestures and their respective actions. The user may be able to add their own hand gestures and respective commands, as well as change previously configured hand gestures. The user will perform these hand gestures to the interface device, which analyzes the images and finds the associated commands. The database containing the hand gestures and respective commands will be located in the memory of the interface device, and in some embodiments additionally in an external server, so the user may reuse the database on similar media devices. The interface device may then direct the media device and the display device to complete the commands issued by the user. For example, the user may show all five fingers with an open palm towards the interface device, which would image the open palm, which may perform an associated action, a non-limiting example of which is starting a particular movie application on the display device.

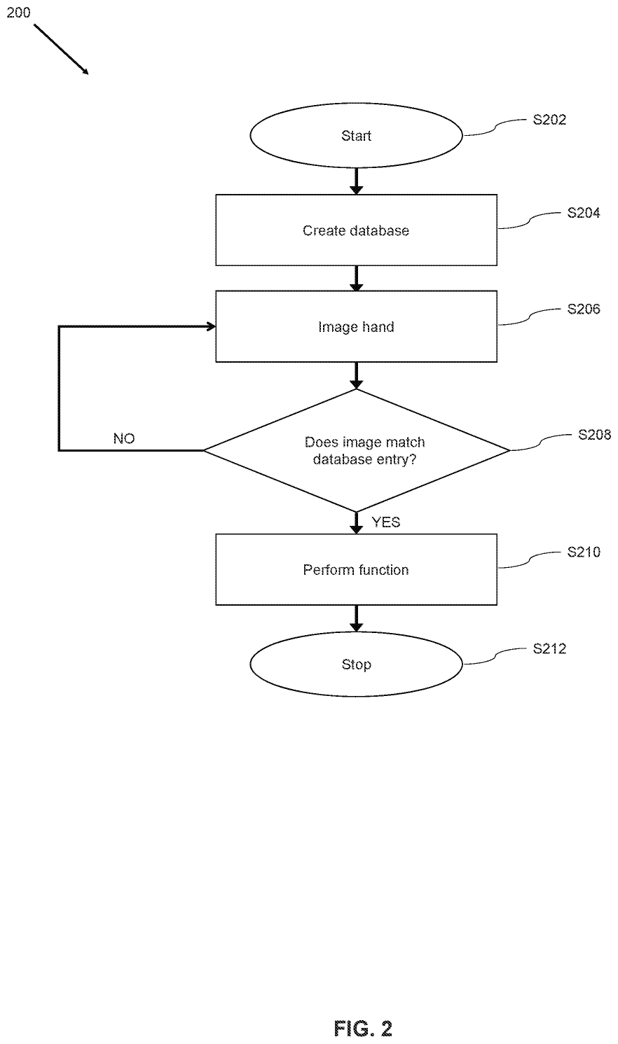

An example system and method for using visual symbolic interface with media devices in accordance with aspects of the present disclosure will now be described in greater detail with reference to FIGS. 2-7.

FIG. 2 illustrates an example algorithm 200 to be executed by a processor for operating an interface device with visual hand gestures, in accordance with aspects of the present disclosure.

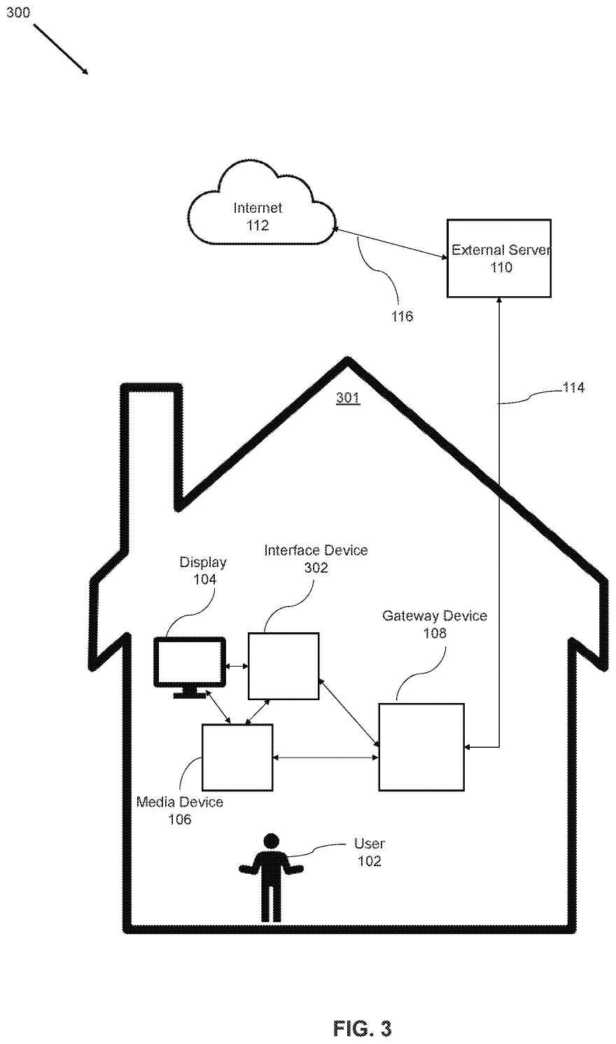

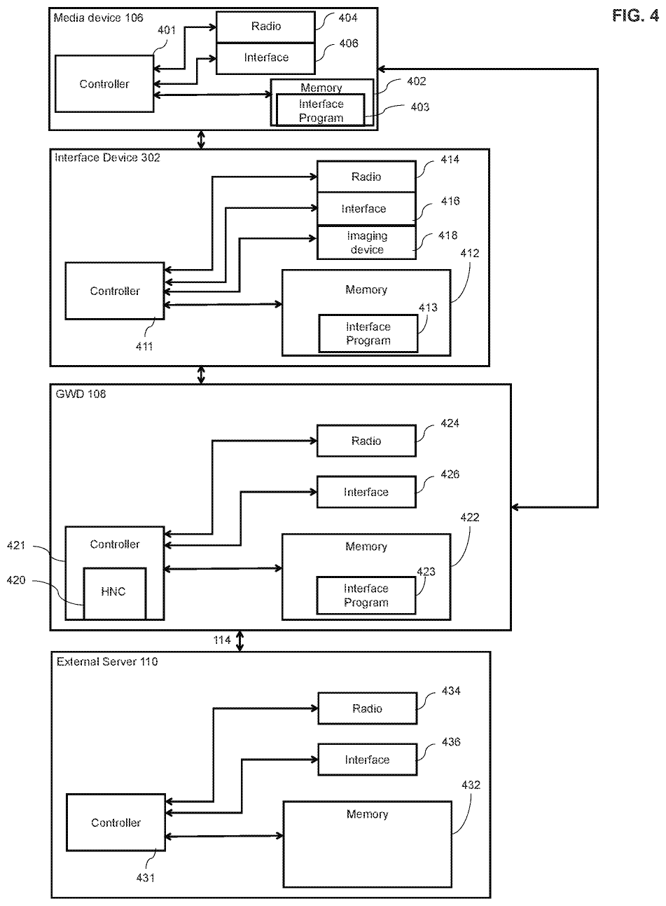

As shown in the figure, algorithm 200 starts (S202) and a database is created (S204). This will be described in greater detail with reference to FIGS. 3 and 4.

FIG. 3 illustrates a communication network 300, in accordance with aspects of the present disclosure.

As shown in FIG. 3, communication network 300 consists of a residence 301, user 102, display 104, media device 106, an interface device 302, gateway device 108, external server 110, Internet 112, and communication channels 114 and 116.

As shown in FIG. 3, media device 106 is connected to display 104, gateway device 108 and interface device 302. Media device 106 is configured to wirelessly communicate with gateway device 108 and interface device 302, e.g., via a Wi-Fi protocol. Interface device 302 is configured to wirelessly communicate with display 104, media device 106 and gateway device 108.

FIG. 4 illustrates an exploded view of media device 106, interface device 302, gateway device 108, and external server 110.

As shown in FIG. 4, media device 106 includes a controller 401; a memory 402, which has stored thereon an interface program 403; a radio 404; and an interface 406.

In this example, controller 401, memory 402, radio 404, and interface 406 are illustrated as individual devices. However, in some embodiments, at least two of controller 401, memory 402, radio 404, and interface 406 may be combined as a unitary device. Whether as individual devices or as combined devices, controller 401, memory 402, radio 404, and interface 406 may be implemented as any combination of an apparatus, a system and an integrated circuit. Further, in some embodiments, at least one of controller 401, memory 402, radio 404, and interface 406 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 401 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of media device 106 in accordance with the embodiments described in the present disclosure.

Memory 402 can store various programming, and user content, and data.

Interface program 403 includes instructions to enable media device 106 to interface with interface device 302.

Radio 404 may include a WLAN interface radio transceiver that is operable to communicate with interface device 302 as shown in FIG. 3. Radio 404 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 404 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 406 can include one or more connectors, such as RF connectors, or Ethernet connectors, and/or wireless communication circuitry, such as 5G circuitry and one or more antennas.

As shown in FIG. 4, interface device 302 includes a controller 411; a memory 412 which has stored thereon an interface program 413; a radio 414; an interface 416; and an imaging device 418.

In this example, controller 411, memory 412, radio 414, and interface 416 are illustrated as individual devices. However, in some embodiments, at least two of controller 411, memory 412, radio 414, and interface 416 may be combined as a unitary device. Further, in some embodiments, at least one of controller 411 and memory 412 may be implemented as a computer having tangible computer-readable media for carrying or having computer-executable instructions or data structures stored thereon.

Controller 411 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 203 in accordance with the embodiments described in the present disclosure.

Memory 412, as will be described in greater detail below, has instructions stored thereon to be executed by controller 411 to cause interface device 302 to: instruct imaging device 418 to obtain the image of the hand; obtain the image data; determine whether the image data corresponds to the hand gesture data; and generate a control signal to instruct media device 106 to perform the action when the image data corresponds to the hand gesture data.

In some embodiments, as will be described in greater detail below, the hand gesture data corresponds to a static hand gesture, and imaging device 418 is configured to obtain the image of the hand as a static image. In some of these embodiments, memory 412, as will be described in greater detail below, has additional instructions stored thereon to be executed by controller 411, wherein imaging device 418 is configured to obtain the image of the hand for a predetermined period of time, to additionally cause interface device 302 to: instruct imaging device 418 to obtain the image of the hand for the predetermined period of time; determine whether the image data for the predetermined period of time corresponds the hand gesture data; and generate a control signal to instruct media device 106 to perform the action when the image data corresponds to the hand gesture data for the predetermined period of time.

In some embodiments, as will be described in greater detail below, the hand gesture data corresponds to a dynamic hand gesture, and imaging device 418 is configured to obtain the image of the hand as a video image.

In some embodiments, as will be described in greater detail below, memory 412 has instructions stored thereon to be executed by controller 411, to cause interface device 302 to: obtain the data structure from memory 412; store the data structure on external server 110; and access the data structure from the external server 110.

In some embodiments, as will be described in greater detail below, memory 412 has instructions stored thereon to be executed by controller 411, to cause interface device 302 to: generate a media device instruction signal to instruct media device 106 to display an icon corresponding to the action; generate an imaging device instruction signal to instruct imaging device 418 to obtain a defining image of the hand and output defining image data based on the defining image of the hand; and create the data structure such that the defining image data is the hand gesture data, and the association associates the defining image data to the action.

Radio 414 may include a WLAN interface radio transceiver that is operable to communicate with interface device 302 as shown in FIG. 3. Radio 404 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 404 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 416 can include one or more connectors, such as RF connectors, or Ethernet connectors, and/or wireless communication circuitry, such as 5G circuitry and one or more antennas. Interface 416 may additionally include a user interface that enables a user to interact and control operation of interface device 302. Non-limiting examples of a user interface include a touch pad and graphic user interface.

Imaging device 418 is any known device or system that is configured to provide a still or video image of an item, a non-limiting example of which is a digital camera.

Returning to FIG. 4, gateway device 108 includes: a controller 421, which has stored therein a home network controller (HNC) 420; a memory 422, which has stored therein a monitoring program 423; a radio 424; and an interface 426.

In this example, controller 421, memory 422, radio 424, and interface 426 are illustrated as individual devices. However, in some embodiments, at least two of controller 421, memory 422, radio 424, and interface 426 may be combined as a unitary device. Whether as individual devices or as combined devices, controller 421, memory 422, radio 424, and interface 426 may be implemented as any combination of an apparatus, a system and an integrated circuit. Further, in some embodiments, at least one of controller 421, memory 422, and interface 426 may be implemented as a computer having non-transitory computer-readable media for carrying or having computer-executable instructions or data structures stored thereon.

Controller 421 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the gateway device 210 in accordance with the embodiments described in the present disclosure.

HNC 420 controls gateway device 108 within the wireless network. HNC 420 may perform tasks such as steering connected devices, a non-limiting example of which is a smart television, from one access point to another.

Memory 422 can store various programming, and user content, and data.

Interface program 423 includes instructions to enable gateway device 108 to interface with interface device 302.

Radio 424 may also be referred to as a wireless communication circuit, such as a Wi-Fi WLAN interface radio transceiver and is operable to communicate with media device 106, interface device 302, and external server 110. Radio 424 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Gateway device 108 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol.

Interface 426 can include one or more connectors, such as RF connectors, or Ethernet connectors, and/or wireless communication circuitry, such as 5G circuitry and one or more antennas. Interface 426 receives content from external server 110 (as shown in FIG. 3) by known methods, non-limiting examples of which include terrestrial antenna, satellite dish, wired cable, DSL, optical fibers, or 5G as discussed above. Through interface 426, gateway device 108 receives an input signal, including data and/or audio/video content, from external server 110 and can send data to external server 110.

Returning to FIG. 4, external server 110 includes: a controller 431; a memory 432; a radio 434; and an interface 436.

In this example, controller 431, memory 432, radio 434, and interface 436 are illustrated as individual devices. However, in some embodiments, at least two of controller 431, memory 432, radio 434, and interface 436 may be combined as a unitary device. Further, in some embodiments, at least one of controller 431 and memory 432 may be implemented as a computer having tangible computer-readable media for carrying or having computer-executable instructions or data structures stored thereon.

Controller 431 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of external server 110 in accordance with the embodiments described in the present disclosure.

Memory 432 can store various programming, and user content, and data.

Radio 434 may include a WLAN interface radio transceiver that is operable to communicate with gateway device 108 as shown in FIG. 3. Radio 434 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 434 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 436 can include one or more connectors, such as RF connectors, or Ethernet connectors, and/or wireless communication circuitry, such as 5G circuitry and one or more antennas. Interface 436 receives data from gateway device 108 (as shown in FIG. 3) by known methods, non-limiting examples of which include terrestrial antenna, satellite dish, wired cable, DSL, optical fibers, or 5G as discussed above. Through interface 436, external server 110 receives an input signal, including data and/or audio/video content, from gateway device 108 and can send data to gateway device 108.

For purposes of discussion only, presume user 102 of residence 301 has just installed interface device 302. During first time use, user 102 may create a user profile on interface device 302. In particular, after interface device 302 is connected to gateway device 108, media device 106, and display 104, interface device 302 may instruct display 104 to prompt user 102 to create their user profile for interface device 302.

User 102 may create a user profile using the user interface portion of interface 416. Controller 411 will store the created user profile in memory 412. During future uses, when operating interface device 302, the user may access the user profile via the interface portion of interface 416. In some embodiments, the profile of user 102 is the default profile for use by interface device 302. In some embodiments, a plurality of different users may create a respective plurality of distinct user profiles.

In some embodiments, when interface device 302 is installed, a preloaded database of default hand gestures and their respective actions are available in memory 412. For example, presume that user 102 is currently watching a movie on media device 106, which is displayed on display 104. Memory 412 may contain a database of default hand gestures and respective actions, a non-limiting example of which is a “high-five” gesture, wherein the respective action associated with the gesture is to stop the current program on media device 106.

For purposes of discussion, presume that user 102 displays a “high-five” gesture to interface device 302 during the movie being played on media device 106. Imaging device 418 will obtain an image of the “high-five” hand gesture. Controller 411 will compare the hand gesture image to the hand gesture image data stored in memory 412. Controller 411 will determine that the hand gesture image matches the hand gesture image data, and determine that the associated action with the hand gesture image data is to stop the current program on media device 106. Controller 411 will send a signal via radio 414 to radio 404 of media device 106, where media device 106 then will stop the current playing program.

The preloaded database of hand gestures and respective actions may have a collection of similar, but slightly different, hand gesture image data gathered through known image recognition and machine learning techniques. For example, memory 412 may have multiple “high-five” hand gesture images. This is to ensure that imaging device 418 is able to correctly identify hand gestures.

Further, in some embodiments, user 102 is able to create new hand gestures and associate them with new respective actions. This will be described in greater detail below.

In some embodiments, user 102 is able to assign new hand gestures to preexisting commands. This allows user 102 to create their own unique database of hand gestures and respective actions. This will be described in greater detail below.

Returning to FIG. 2, after a database is created (S204), the hand is imaged (S206).

In operation, returning to FIG. 3, presume user 102 would like to watch a movie on display 104. To do this, in accordance with aspects of the present disclosure, user 102 may start this operation, watching the movie on display 104, by merely performing a hand gesture. In particular, in accordance with aspects of the present disclosure, user 102 may, first, turn on media device 106, as well as display 104 by displaying a hand gesture to interface device 302. The hand gesture displayed by user 102 must be the hand gesture associated with the action that turns on both media device 106 and display 104. With reference to FIG. 4, user 102 will display a hand gesture to imaging device 418 of interface device 302 for a predetermined period of time, a non-limiting example of which is 2 seconds. Controller 411 will then execute instructions stored in memory 412 to cause imaging device 418 to obtain the image of the hand gesture displayed by user 102.

In some embodiments, user 102 may display a dynamic hand gesture, wherein a dynamic hand gesture includes a gesture of a hand in motion or a combination of more than one static hand gestures. Non-limiting examples of dynamic hand gestures may be user 102 waving their hand, or displaying consecutive static hand gestures that are associated with a single action. This will be described in greater detail below.

Returning to FIG. 2, after the hand is imaged (S206), it is determined if the image matches an entry in the database (S208). For example, after user 102 displays a hand gesture to interface device 302, imaging device 418 will obtain an image of the hand gesture. Controller 411 then compares the hand gesture image to available hand gesture image data, stored in memory 412, associated with user 102. Controller 411 will determine whether the hand gesture image matches any hand gesture image data available in memory 412.

In some embodiments, the hand gesture image and respective action data of user 102 will be stored in external server 110, e.g. in a cloud system. In such case, user 102 will operate interface device 302 normally, by displaying a hand gesture. Imaging device 418 will obtain the image of the hand gesture. Controller 411 of interface device 302 will compare the image to available hand gesture image data in memory 412, as referenced in FIG. 4. If none are found, a signal will be sent from radio 414 of interface device 302 to radio 424 of gateway device 108, which then relays the signal to radio 434 of external server 110. External server 110 will have the hand gesture image and respective action data of user 102 stored in memory 432. This hand gesture image and respective action data of user 102 is then sent back to interface device 302, which will again compare it to the image collected by imaging device 418.

Returning to FIG. 2, if is determined that the image does not match an entry in the database (N at S208), then the hand is imaged again (Return to S206). For example, presume that the image data obtained by imaging device 418 is not comparable to any gestures available in the hand gesture image and respective action data of user 102 stored in memory 412 of interface device 302 or in memory 432 of external server 110. Interface device 302 will not complete any task, prompting user 102 to display the hand gesture again. Imaging device 418 will then attempt to obtain the image of the hand gesture again.

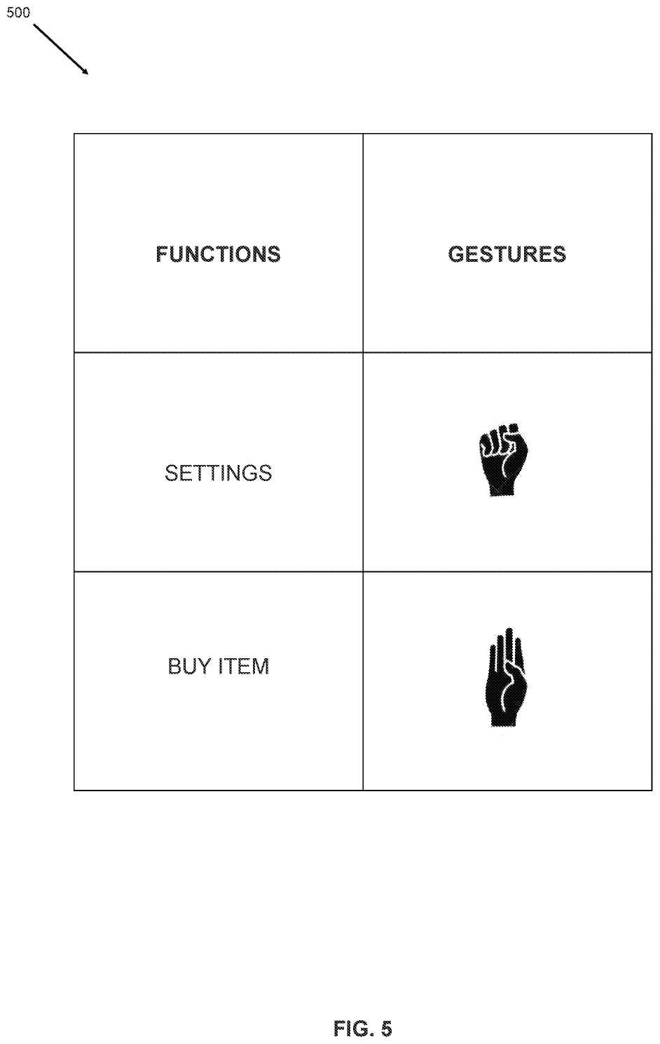

Returning to FIG. 2, if is determined that the image does match an entry in the database (Y at S208), then the corresponding action is performed (S210). This will be described in greater detail with reference to FIGS. 5-7.

FIG. 5 illustrates a chart 500 showcasing non-limiting examples of user made hand gestures and their respective actions.

With reference to FIG. 5, user 102 has the option of creating their own hand gestures for respective actions. For example, presume that media device 106 has the capability of purchasing a movie on the internet. User 102 may decide to create a hand gesture that will purchase the item currently being displayed on display 104. As shown in FIG. 5, user 102 will display four fingers in the air with their thumb over their palm to interface device 302, repeating this hand gesture multiple times to ensure that imaging device 418 obtains enough images. This prevents future errors where controller 411 fails to associate displayed hand gestures to hand gesture image data stored in memory 412. User 102 then, using a remote or a client device, assigns this hand gesture to the action of purchasing item. From that point on, when user 102 displays four fingers in the air with their thumb over their palm to interface device 302, imaging device 418 would capture the image. Controller 411 would determine that the hand gesture matches hand gesture image data stored in memory 412, associate the image with purchasing the item currently being displayed on display 104, and send a signal via radio 414 to radio 404 of media device 106 to purchase the item currently being displayed on display 104.

Further, user 102 may change a hand gesture that is already associated with an action. Presume that a “high-five” hand gesture is associated with accessing the settings of media device 106. User 102 may decide to change the hand gesture to a closed fist. User 102 will display a closed first gesture to interface device 302, repeating this hand gesture multiple times to ensure that imaging device 418 obtains enough images. User 102 then, using a remote or a client device, assigns this hand gesture to the action of going to the settings of media device 106. From that point on, when user 102 displays a closed first to interface device 302, imaging device 418 would capture the image. Controller 411 would determine that the hand gesture matches hand gesture image data stored in memory 412, associate the image with going to the settings of media device 106, and send a signal via radio 414 to radio 404 of media device 106 to go to the settings of media device 106.

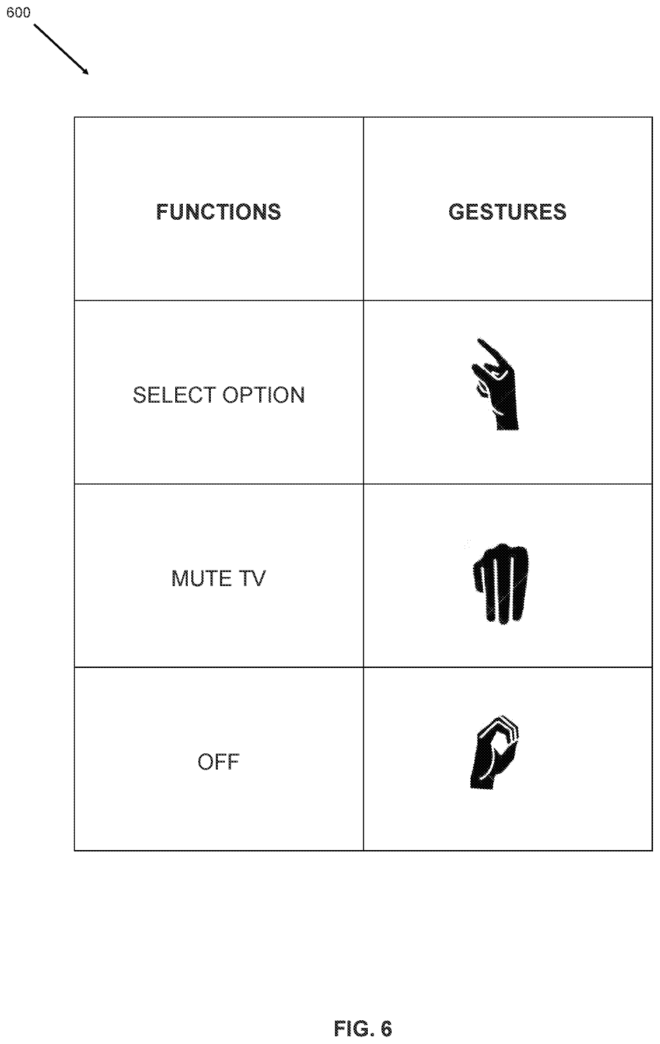

FIG. 6 illustrates a chart 600 showcasing non-limiting examples of pre-loaded hand gestures stored in the database and their respective actions.

With reference to FIG. 6, interface device 302 contains default hand gestures associated with respective actions. These default hand gestures and respective actions are present during first use, before user 102 alters any hand gestures or creates new hand gestures. Presume that media device 106 is playing a movie which is being displayed on display 104. User 102 may decide to mute the movie for any given reason, in which case they would display three fingers down to interface device 302. Imaging device 418 would capture the image, and controller 411 of interface device 302 would send a signal via radio 414 to radio 404 of media device 106 to mute the media currently being displayed on display 104.

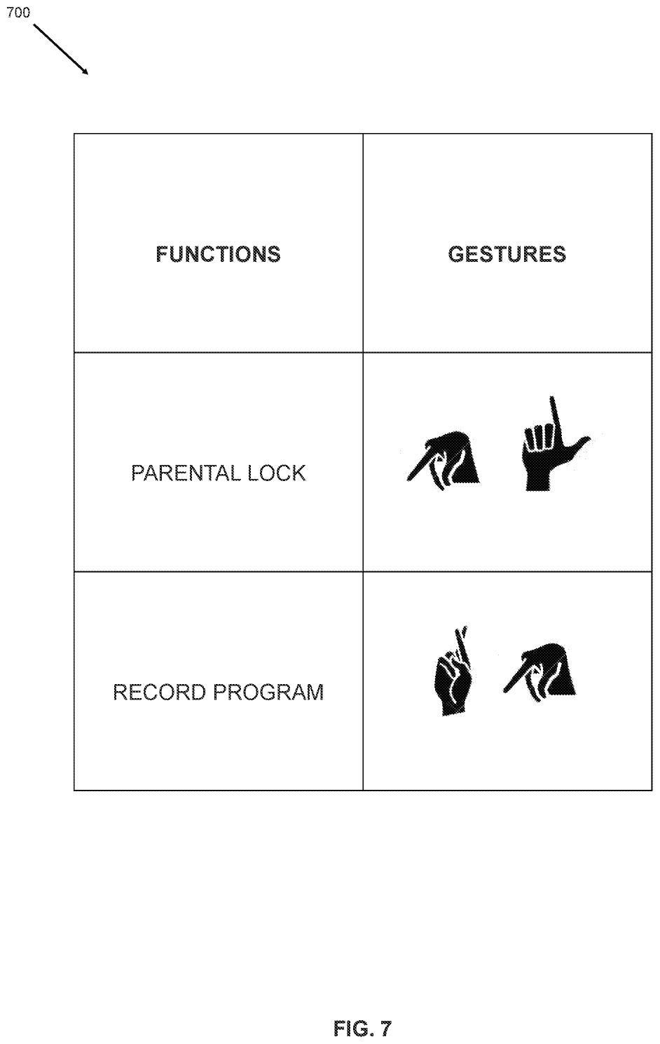

FIG. 7 illustrates a chart 700 showcasing non-limiting examples of dynamic hand gestures and their respective actions.

With reference to FIG. 7, some actions may be associated with a chain of consecutive hand gestures. Presume that user 102 would like to put a parental lock on a certain movie. User 102 would display the first hand gesture for a predetermined period of time, and then display the second hand gesture for a predetermined period of time, a non-limiting example of a predetermined period of time being 1 second. Imaging device 418 will obtain the dynamic image of the hand gestures as a video image. Controller 411 will then analyze the video image and send a signal via radio 414 to radio 404 of media device 106 to add a parental lock to the media currently being displayed on display 104.

Further, some actions may be associated with a moving hand gesture. Presume that user 102 would like to turn on media device 106 and display 104, and the respective hand gesture for this action is waving at interface device 302. Imaging device 418 is configured to obtain video images as well as static images; thus, imaging device 418 will obtain the video image of user 102 waving. Controller 411 will determine that memory 412 contains data for user 102 that associates waving with turning on both media device 106 and display 104. Controller 411 will then send a signal to both media device 106 and display 104, instructing both devices to turn on.

Returning to FIG. 2, after the corresponding action is performed (S210), algorithm 200 stops (S212). For example, presume user 102 displayed a closed first gesture to interface device 302, prompting interface device 302 to send a signal to media device 106 to access the settings. Interface device 302 correctly completed its action, and user 102 continues to use media device 106 until they need to use interface device 302 again.

In some embodiments, interface device 302 may have multiple users. When using interface device 302 after first time use, imaging device 418 will obtain the image of the user and determine which user it is, e.g., by any known facial recognition technology. For example, assume user 102 is using interface device 302 after another user had finished. Imaging device 418 will capture the image of user 102, where controller 411 will then process the image. Controller 411 will check memory 412 and check cloud data received from memory 432 of external server 110 to determine that the image data is associated with user 102.

As interface device 302 may have multiple users, each user may have a different set of hand gestures and respective actions. For example, a “high-five” gesture for one user may turn on media device 106 and display 104, but the same gesture for a different user may pause the media being played on media device 106.

In some embodiments, the interface device may be a client device, e.g. a cell phone, with a downloaded application, configuring the client device to operate similarly to interface device 302 discussed above.

In some embodiments, user 102 may use their user data on another media device model that is identical to the original. For example, if user 102 is in a different location than media device 106, but has access to the same model of media device 106, user 102 may use their user data that is stored in external server 110. This allows user 102 to use their user data anywhere assuming they have access to the same model as media device 106, and ensures that user 102 does not have to recreate their hand gestures and respective actions.

Interface device 302 will also have a settings page, which displays the mapping table for the hand gestures and respective actions. For example, presume user 102 would like to watch a movie, but has forgotten their hand gestures and respective actions. Using interface device 302, they can select a settings key, which will instruct display 104 to display the mapping table associated with user 102. In some embodiments, when user 102 has a client device with an application associated with interface device 302, user 102 may use their client device to access their respective mapping table.

Many media devices today provide plethora of features and applications for a user to access. It may be difficult and tedious to navigate the interface to allow the user to access the media they are looking for using a traditional hand-held remote controller. As technology has progressed, some devices include voice interface where a user can speak to navigate their media devices. However, this technology may not be helpful to users who are speech or hearing impaired. Background noises may also alter the voice command given by the user. Hence, media devices need a simple interface that allows users to efficiently and effectively use and navigate their media devices. This can be achieved through a visual interface.

In accordance with the present disclosure, a user uses an interface device with a media device and a display device. The interface device is used to capture hand gestures from the user, and to determine the command associated with the captured image of the hand gesture. The interface device will instruct the media device and the display device to complete the command given by the user operating the interface device. The media device and the display device will then complete this command.

Thus, the present disclosure as disclosed creates an effective and efficient way for operating a media device and display device through the use of hand gestures by a user and an interface device.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An interface device for use with a media device and a hand, the media device being configured to provide media and to perform an action with reference to the media, said interface device comprising:
a memory having instructions and a data structure stored therein, the data structure including hand gesture data and an association associating the hand gesture data to the action;
an imaging device configured to obtain an image of the hand and output image data based on the image of the hand; and
a processor configured to execute the instructions stored on said memory to cause said interface device to:
instruct said imaging device to obtain the image of the hand;
obtain the image data;
determine whether the image data corresponds to the hand gesture data; and
generate a control signal to instruct the media device to perform the action when the image data corresponds to the hand gesture data.

2. The interface device of claim 1,
wherein the hand gesture data corresponds to a static hand gesture, and
wherein said imaging device is configured to obtain the image of the hand as a static image.

3. The interface device of claim 2,
wherein said imaging device is configured to obtain the image of the hand for a predetermined period of time, and
wherein said processor is configured to execute the instructions stored on said memory to additionally cause said interface device to:
instruct said imaging device to obtain the image of the hand for the predetermined period of time;
determine whether the image data for the predetermined period of time corresponds the hand gesture data; and
generate a control signal to instruct the media device to perform the action when the image data corresponds to the hand gesture data for the predetermined period of time.

4. The interface device of claim 1,
wherein the hand gesture data corresponds to a dynamic hand gesture, and
wherein said imaging device is configured to obtain the image of the hand as a video image.

5. The interface device of claim 1, for additional use with an external server, wherein said processor is configured to execute the instructions stored on said memory to additionally cause said interface device to:
obtain the data structure from said memory;
store the data structure on the external server; and
access the data structure from the external server.

6. The interface device of claim 1, wherein said processor is configured to execute the instructions stored on said memory to additionally cause said interface device to:
generate a media device instruction signal to instruct the media device to display an icon corresponding to the action;
generate an imaging device instruction signal to instruct said imaging device to obtain a defining image of the hand and output defining image data based on the defining image of the hand; and
create the data structure such that the defining image data is the hand gesture data, and the association associates the defining image data to the action.

7. A method of using an interface device with a media device and a hand, the media device being configured to provide media and to perform an action with reference to the media, said method comprising:
instructing, via a processor configured to execute instruction stored on a memory additionally having stored therein a data structure including hand gesture data and an association associating the hand gesture data to the action, an imaging device to obtain an image of the hand;
obtaining, via the processor and from the imaging device, the image data based on the image of the hand;
determining, via the processor, whether the image data corresponds the hand gesture data; and
generating, via the processor, a control signal to instruct the media device to perform the action when the image data corresponds to the hand gesture data.

8. The method of claim 7,
wherein the hand gesture data corresponds to a static hand gesture, and
wherein said obtaining, via the processor and from the imaging device, the image data based on the image of the hand comprises obtaining the image of the hand as a static image.

9. The method of claim 8,
wherein said obtaining, via the processor and from the imaging device, the image data based on the image of the hand comprises obtaining the image of the hand for a predetermined period of time, and
wherein said method further comprises:
instructing, via the processor, the imaging device to obtain the image of the hand for the predetermined period of time;
determining, via the processor, whether the image data for the predetermined period of time corresponds the hand gesture data; and
generating, via the processor, a control signal to instruct the media device to perform the action when the image data corresponds to the hand gesture data for the predetermined period of time.

10. The method of claim 7,
wherein the hand gesture data corresponds to a dynamic hand gesture, and
wherein said instructing the imaging device to obtain the image of the hand comprises instructing the imaging device to obtain the image of the hand as a video image.

11. The method of claim 7, for additional use with an external server, said method further comprising:
obtaining, via the processor, the data structure from the memory;
storing, via the processor, the data structure on the external server; and
accessing, via the processor, the data structure from the external server.

12. The method of claim 7, further comprising:
generating, via the processor, a media device instruction signal to instruct the media device to display an icon corresponding to the action;
generating, via the processor, an imaging device instruction signal to instruct the imaging device to obtain a defining image of the hand and output defining image data based on the defining image of the hand; and
creating, via the processor, the data structure such that the defining image data is the hand gesture data, and the association associates the defining image data to the action.

13. A non-transitory, computer-readable media having computer-readable instructions stored thereon, the computer-readable instructions being capable of being read by an interface device for use with a media device and a hand, the media device being configured to provide media and to perform an action with reference to the media, wherein the computer-readable instructions are capable of instructing the interface device to perform the method comprising:
instructing, via a processor configured to execute instruction stored on a memory additionally having stored therein a data structure including hand gesture data and an association associating the hand gesture data to the action, an imaging device to obtain an image of the hand;
obtaining, via the processor and from the imaging device, the image data based on the image of the hand;
determining, via the processor, whether the image data corresponds to the hand gesture data; and
generating, via the processor, a control signal to instruct the media device to perform the action when the image data corresponds to the hand gesture data.

14. The non-transitory, computer-readable media of claim 13, wherein the computer-readable instructions are capable of instructing the interface device to perform the method
wherein the hand gesture data corresponds to a static hand gesture, and
wherein said obtaining, via the processor and from the imaging device, the image data based on the image of the hand comprises obtaining the image of the hand as a static image.

15. The non-transitory, computer-readable media of claim 14, wherein the computer-readable instructions are capable of instructing the interface device to perform the method
wherein said obtaining, via the processor and from the imaging device, the image data based on the image of the hand comprises obtaining the image of the hand for a predetermined period of time, and
wherein the method further comprises:
instructing, via the processor, the imaging device to obtain the image of the hand for the predetermined period of time;
determining, via the processor, whether the image data for the predetermined period of time corresponds to the hand gesture data; and
generating, via the processor, a control signal to instruct the media device to perform the action when the image data corresponds to the hand gesture data for the predetermined period of time.

16. The non-transitory, computer-readable media of claim 13, wherein the computer-readable instructions are capable of instructing the interface device to perform the method
wherein the hand gesture data corresponds to a dynamic hand gesture, and
wherein said instructing the imaging device to obtain the image of the hand comprises instructing the imaging device to obtain the image of the hand as a video image.

17. The non-transitory, computer-readable media of claim 13, wherein the computer-readable instructions are capable of instructing the interface device to perform the method further comprising:
obtaining, via the processor, the data structure from the memory; and
accessing, via the processor, the data structure from the external server.

18. The non-transitory, computer-readable media of claim 13, wherein the computer-readable instructions are capable of instructing the interface device to perform the method further comprising:
generating, via the processor, a media device instruction signal to instruct the media device to display an icon corresponding to the action;
generating, via the processor, an imaging device instruction signal to instruct the imaging device to obtain a defining image of the hand and output defining image data based on the defining image of the hand; and
creating, via the processor, the data structure such that the defining image data is the hand gesture data, and the association associates the defining image data to the action.
